(19) United States
(12) Patent Application Publication
(10) Pub. No.: US 2019/0345715 A1
(43) Pub. Date: Nov. 14, 2019

(54) REGENERATED BLOCK CONCRETE PREFABRICATED LAMINATED SLAB AND MANUFACTURING PROCESS THEREOF

(71) Applicant: SOUTH CHINA UNIVERSITY OF TECHNOLOGY, Nansha Guangzhou, Guangdong (CN)

(72) Inventors: Bo WU, Guangdong (CN); Simin JIAN, Guangdong (CN)

(73) Assignee: SOUTH CHINA UNIVERSITY OF TECHNOLOGY, Nansha Guangzhou, Guangdong (CN)

(21) Appl. No.: 16/472,213

(22) PCT Filed: Nov. 30, 2017
(86) PCT No.: PCT/CN2017/114150

§ 371 Date: Jun. 21, 2019

(30) Foreign Application Priority Data
Oct. 16, 2017 (CN) 201710975373.4

(51) Int. Cl. E04B 5/04; B28B 23/02

(52) U.S. Cl. CPC E04B 5/04; B28B 23/02

(57) ABSTRACT

A regenerated block concrete prefabricated laminated slab includes a new concrete, waste concrete blocks, and a steel bar mesh on a bottom of the slab. The waste concrete blocks can protrude out from a surface part of the new concrete, but a protruding height is no more than 25 mm, and the protruding height is limited by an assembling die. The assembling die comprises a casting die and a height-limiting cover plate, a side die of the casting die is reserved with a steel bar positioning hole, and a vertical position of the height-limiting cover plate is positioned at four corners of the casting die through screws, limiting nuts and gaskets of different thicknesses. A manufacturing process of the regenerated block concrete prefabricated laminated slab is also provided.

### BACKGROUND

### Technical Field

The present invention relates to the field of waste concrete recycling technologies, and more particularly, to a regenerated block concrete prefabricated laminated slab and a manufacturing process thereof.

### Description of Related Art

Construction industrialization is one of the development trends of contemporary construction technology. Compared with a cast-in-situ concrete structure, a prefabricated concrete structure has the advantages of industrialized production, few wet constructions on site, fast construction speed, energy conservation, etc. As an assembled integral component with excellent integrity, the concrete prefabricated laminated slab has been widely used in prefabricated construction. Meanwhile, since the exploitation of natural sand and gravel damages the environment and the reserves are decreasing day by day, the waste concrete, as a precious “special resource”, has attracted extensive attention at home and abroad for recycling. Compared with the regenerated aggregate, the use of the waste concrete block with a larger size can greatly simplify the recycling process of the waste concrete, and meanwhile, the use of the waste concrete block as concrete instead of aggregate can also significantly reduce the amount of cement, which has more obvious environmental protection benefits. However, due to the large size of the waste concrete block, the waste concrete block cannot be used in a traditional concrete prefabricated laminated slab, and this problem needs to be solved urgently. However, the present invention allows the waste concrete blocks to protrude out from a surface of the new concrete while increasing a surface roughness of the prefabricated laminated slab using the waste concrete blocks protruded out, which is an effective way to solve this problem.

To sum up, the prior art has the problem that the waste concrete block cannot be recycled in the concrete prefabricated laminated slab due to large size.

### SUMMARY

An object of the present invention is to overcome the defects of the prior art, which allows a waste concrete block to protrude out from a surface of a new concrete by a certain height, and limits the height by an assembling die, so that binding of steel bars in a surface of a slab during on-site construction is not affected by the waste concrete block protruded out on one hand, so that the problem that the waste concrete block cannot be recycled in the concrete prefabricated laminated slab due to large size is solved. On the other hand, the waste concrete blocks protruded out can significantly increase a surface roughness of the prefabricated laminated slab, thus improving integrity between the prefabricated laminated slab and a post-cast concrete layer.

Another object of the present invention is to provide a manufacturing process of a regenerated block concrete prefabricated laminated slab.

The objects of the present invention are achieved through one of the following technical solutions.

A regenerated block concrete prefabricated laminated slab comprises a new concrete, a waste concrete block and a steel bar mesh on a bottom of the slab. The waste concrete block and the new concrete are cast in a mixed manner, a gap between the waste concrete blocks after casting is filled with the new concrete, a ratio of a horizontal projected area of the waste concrete block protruded out from a surface part of the new concrete to a surface area of the new concrete is no less than 1:3, a protruding height is no more than 25 mm, and the protruding height is limited by an assembling die. The assembling die comprises a casting die and a height-limiting cover plate, a side die of the casting die is reserved with a steel bar positioning hole, and a vertical position of the height-limiting cover plate is positioned at four corners of the casting die through screws, limiting nuts and gaskets of different thicknesses.

Further, the waste concrete block is a block formed by crushed waste concrete of old buildings, roads, bridges or dams after removing protective layers and all or a part of steel bars.

Further, the new concrete is a natural aggregate concrete or a regenerated aggregate concrete with a compressive strength no less than 25 MPa, and a thickness of the new concrete after casting is no less than 60 mm.

Further, a characteristic size of the waste concrete block is 60 mm to 100 mm, and a mass ratio of the waste concrete block to the new concrete is 1:3 to 1:1.

Further, the steel bar mesh on the bottom of the slab is formed by binding two-way steel bars perpendicular to each other, and a length of the two-way steel bar extending out of a slab edge is required to meet lapping and anchoring requirements.

A manufacturing process of the regenerated block concrete prefabricated laminated slab comprises following steps:

(1) inserting a steel bar through the steel bar positioning hole reserved in the side die of the casting die, and binding the steel bars to form the steel bar mesh on the bottom of the slab;

(2) putting the waste concrete block fully wetted in advance into an empty cavity surrounded by the side die of the casting die, and stirring the waste concrete block to evenly distribute the waste concrete block in the empty cavity;

(3) casting enough new concrete into the empty cavity surrounded by the side die of the casting die, then threading the height-limiting cover plate through a screw rod from top to bottom and placing the height-limiting cover plate on the gasket, and tightening the limiting nut to prevent the height of the waste concrete block protruding out from the surface of the new concrete from exceeding a limit value during vibrating and stirring; and

(4) fully vibrating and stirring the regenerated block concrete prefabricated laminated slab using a vibrating table, and then performing steam curing.

The present invention has the following advantages and effects relative to the prior art.

(1) The waste concrete block is allowed to protrude out from the surface of the new concrete by a certain height, and the height is limited by the assembling die, so that the binding of steel bars in the surface of the slab during on-site construction is not affected by the waste concrete block protruded out, thereby solving the problem that the waste concrete block cannot be used in the concrete prefabricated laminated slab due to large size.

(2) The waste concrete block protruded out from the surface of the new concrete can significantly increase the surface roughness of the prefabricated laminated slab, and the integrity between the prefabricated laminated slab and the post-cast concrete layer can be ensured without a brooming process in a conventional manufacturing process of the prefabricated concrete slab.

### BRIEF DESCRIPTION OF THE DRAWINGS

FIG. 1 is a schematic diagram of a regenerated block concrete prefabricated laminated slab and an assembling die.

FIG. 2 is a schematic diagram of a regenerated block concrete prefabricated laminated slab.

As shown in the drawings: 1 refers to new concrete; 2 refers to waste concrete block; 3 refers to steel mesh at bottom of slab; 4 refers to casting die; 5 refers to height-limiting cover plate; 6 refers to side die; 7 refers to screws; 8 refers to limiting nuts; 9 refers to gaskets.

### DESCRIPTION OF THE EMBODIMENTS

The present invention is further described in details below with reference to the embodiments and the drawings, but the implementation of the present invention is not limited thereto. It should be noted that all the processes hereunder can be implemented by those skilled in the art with reference to the prior art if not specifically described.

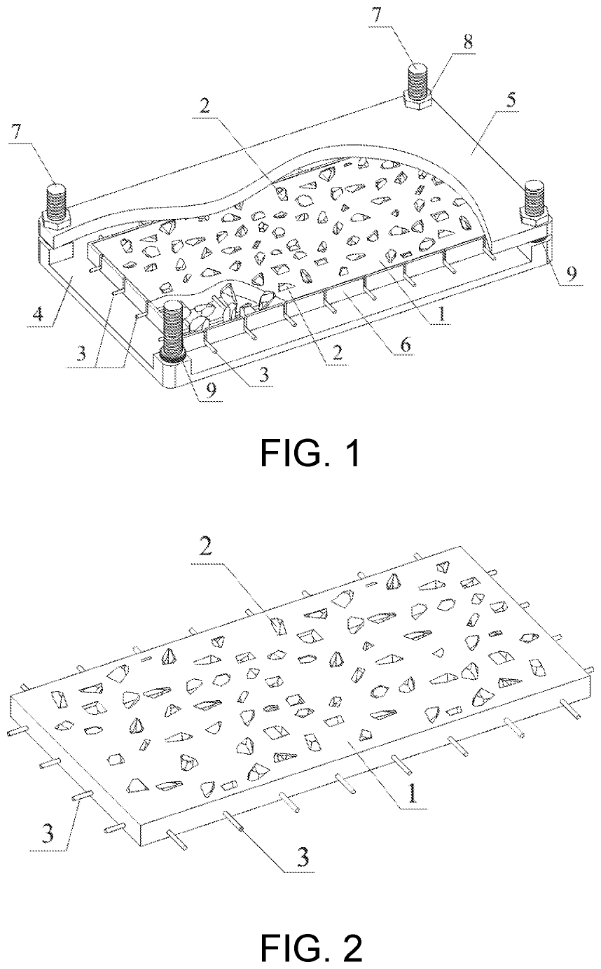

As shown in FIG. 1 and FIG. 2, a regenerated block concrete prefabricated laminated slab comprises a new concrete 1, a waste concrete block 2 and a steel bar mesh 3 on a bottom of the slab. The waste concrete blocks and the new concrete are cast in a mixed manner, a gap between the waste concrete blocks after casting is filled with the new concrete, a ratio of a horizontal projected area of the waste concrete blocks protruded out from a surface part of the new concrete to a surface area of the new concrete is no less than 1:3, a protruding height is no more than 25 mm, and the protruding height is limited by an assembling die. The assembling die comprises a casting die 4 and a height-limiting cover plate 5. A side die 6 of the casting die is reserved with a steel bar positioning hole, and a vertical position of the height-limiting cover plate is positioned at four corners of the casting die through screws 7, limiting nuts 8 and gaskets 9 with different thicknesses.

In the embodiment, a width of the regenerated block concrete prefabricated laminated slab is 1200 mm, and a span of the regenerated block concrete prefabricated laminated slab is 3300 mm. A thickness of the new concrete 1 is 100 mm. A characteristic size of the waste concrete block 2 is 60 mm to 100 mm.

In the embodiment, the steel mesh 3 on the bottom of the slab is formed by binding the steel bars in a span direction and a width direction. When the steel bars C10@200 are distributed in the span direction, the two ends extend out of the slab edge by 150 mm. When the steel bars C8@200 are distributed in the width direction, the two ends extend out of the slab edge by 180 mm.

In the embodiment, a height of the side die 6 of the casting die 4 is 100 mm, and a spacing between the reserved steel bar positioning hole is 200 mm. After the height-limiting cover plate 5 is positioned, a net spacing between a bottom surface thereof and a top surface of the side die 6 is 25 mm.

A manufacturing process of the regenerated block concrete prefabricated laminated slab above comprises the following steps.

(1) Inserting a steel bar through the steel bar positioning hole reserved in the side die 6 of the casting die 4, and binding the steel bars to form the steel bar mesh 3 on the bottom of the slab.

(2) Putting the waste concrete blocks 2 fully wetted in advance into an empty cavity surrounded by the side die 6 of the casting die 4, and stirring the waste concrete blocks 2 to evenly distribute the waste concrete blocks in the empty cavity.

(3) Casting enough new concrete 1 into the empty cavity surrounded by the side die 6 of the casting die 4, then threading the height-limiting cover plate 5 through a screw rod 7 from top to bottom and placing the height-limiting cover plate 5 on the gasket 9, and tightening the limiting nut 8 to prevent the height of the waste concrete blocks 2 protruded out from the surface of the new concrete 1 from exceeding a limit value during vibrating and stirring.

(4) Fully vibrating and stirring the regenerated block concrete prefabricated laminated slab using a vibrating table, and then performing steam curing.

According to the method of the present invention, a series of embodiments can also be developed, which do not limit the present invention in any form. Therefore, any other amendment, modification, replacement, combination and simplification made without departing from the spiritual substance and principle of the present invention shall be deemed as equivalent substitute modes, and shall all fall within the protection scope of the present invention.

1. A regenerated block concrete prefabricated laminated slab, characterized in that, the slab comprising a new concrete, a plurality of waste concrete blocks and a steel bar mesh on a bottom of the slab, the waste concrete blocks and the new concrete are cast in a mixed manner, a gap between the waste concrete blocks after casting is filled with the new concrete, a ratio of a horizontal projected area of the waste concrete blocks protruded out from a surface part of the new concrete to a surface area of the new concrete is no less than 1:3, a protruding height is no more than 25 mm, and the protruding height is limited by an assembling die; the assembling die comprises a casting die and a height-limiting cover plate, a side die of the casting die is reserved with a steel bar positioning hole, and a vertical position of the height-limiting cover plate is positioned at four corners of the casting die through screws, limiting nuts and gaskets of different thicknesses.

2. The regenerated block concrete prefabricated laminated slab according to claim 1, wherein each of the waste concrete blocks is a block formed by crushing waste concrete of old buildings, roads, bridges or darns after removing protective layers and all or a part of steel bars.

3. The regenerated block concrete prefabricated laminated slab according to claim 1, wherein the new concrete is a natural aggregate concrete or a regenerated aggregate concrete with a compressive strength no less than 25 MPa, and a thickness of the new concrete after casting is no less than 60 mm.

4. The regenerated block concrete prefabricated laminated slab according to claim 1, wherein a characteristic size of each of the waste concrete blocks is 60 mm to 100 mm, and a mass ratio of the waste concrete blocks to the new concrete is 1:3 to 1:1.

5. The regenerated block concrete prefabricated laminated slab according to claim 1, wherein the steel bar mesh on the bottom of the slab is formed by binding two-way steel bars perpendicular to each other, and a length of the two-way steel bar extending out of a slab edge is required to meet lapping and anchoring requirements.

6. A manufacturing process of the regenerated block concrete prefabricated laminated slab according to claim 1, the manufacturing process comprising following steps:
(1) inserting a steel bar through the steel bar positioning hole reserved in the side die of the casting die, and binding the steel bars to form the steel bar mesh on the bottom of the slab;
(2) putting the waste concrete blocks fully wetted in advance into an empty cavity surrounded by the side die of the casting die, and stirring the waste concrete blocks to evenly distribute the waste concrete blocks in the empty cavity;
(3) casting enough new concrete into the empty cavity surrounded by the side die of the casting die, then threading the height-limiting cover plate through a screw rod from top to bottom and placing the height-limiting cover plate on the gasket, and tightening the limiting nut to prevent a height of the waste concrete blocks protruded out from the surface part of the new concrete from exceeding a limit value during vibrating and stirring; and
(4) fully vibrating and stirring the regenerated block concrete prefabricated laminated slab using a vibrating table, and then performing steam curing.
